(19) United States
(12) Patent Application Publication
(10) Pub. No.: US 2008/0107042 A1
(43) Pub. Date: May 8, 2008

(54) System and Method for Configuring a Computing Device

(76) Inventors: Varadachari Rengarajan, Cupertino, CA (US); Janakiraman Gopalan, Cupertino, CA (US)

Correspondence Address: FAY KAPLUN & MARCIN, LLP, 150 BROADWAY, SUITE 702, NEW YORK, NY, 10038, US

(21) Appl. No.: 11/556,481

(22) Filed: Nov. 3, 2006

(51) Int. Cl. H04L 12/28

(52) U.S. Cl. 370/254

(57) ABSTRACT

Described is system and method for configuring a computing device. A device identifier of the device is obtained. A first configuration value for the device is determined as a function of the device identifier. A configuration data file is generated as a function of the first configuration value. The configuration data file is transmitted to the device. The first configuration value in the configuration data file is replaced with a second configuration value utilized by the device.

### FIELD OF THE INVENTION

The present invention relates generally to systems and methods for configuring computing devices.

### BACKGROUND

An entity (e.g., business, hospital, school, etc.) utilizing a computing network may take steps to ensure that computing devices in the network are configured in a predetermined manner, e.g., based on geographic region, activity, device-type, etc. However, due to a number of the computing devices in the network (hundreds, if not thousands), managing and enforcing configuration policies can require significant costs in time, personnel, training, software, etc. That is, it may require significant effort to propagate configuration changes from headquarters to employee level, and vice-versa, and across these levels. Additionally, the configuration policies may attempt to limit user-initiated changes that are typically difficult to prevent and/or reverse (especially on a per-device level).

### SUMMARY OF THE INVENTION

The present invention relates to a system and method for configuring a computing device. A device identifier of the device is obtained. A first configuration value for the device is determined as a function of the device identifier. A configuration data file is generated as a function of the first configuration value. The configuration data file is transmitted to the device. The first configuration value in the configuration data file is replaced with a second configuration value utilized by the device.

### DESCRIPTION OF THE DRAWINGS

FIG. 1 shows an exemplary embodiment of a system for configuring a computing device according to the present invention.

FIG. 2 shows an exemplary embodiment of a method for configuring a computing device according to the present invention.

FIG. 3a shows an exemplary embodiment of a skeleton variance file according to the present invention.

FIG. 3b shows an exemplary embodiment of a template according to the present invention.

FIG. 3c shows an exemplary embodiment of a variance file according to the present invention.

FIG. 4 shows an exemplary embodiment of a device profile according to the present invention.

### DETAILED DESCRIPTION

The present invention may be further understood with reference to the following description and the appended drawings, wherein like elements are referred to with the same reference numerals. The exemplary embodiments of the present invention describe a system and method for configuring a computing device. According to the exemplary embodiments of the present invention, configuration data may be propagated upward, downward and across levels of a computing network, ensuring uniform configurations between parent-children devices (e.g., access point—mobile unit), sibling devices (e.g., mobile unit—mobile unit), etc. It should also be noted that while the exemplary embodiments are described with reference to device configurations and configuration policies, those skilled in the art will understand that the exemplary embodiments may also be applied for use in other types of device management functions such as provisioning, performance monitoring, etc.

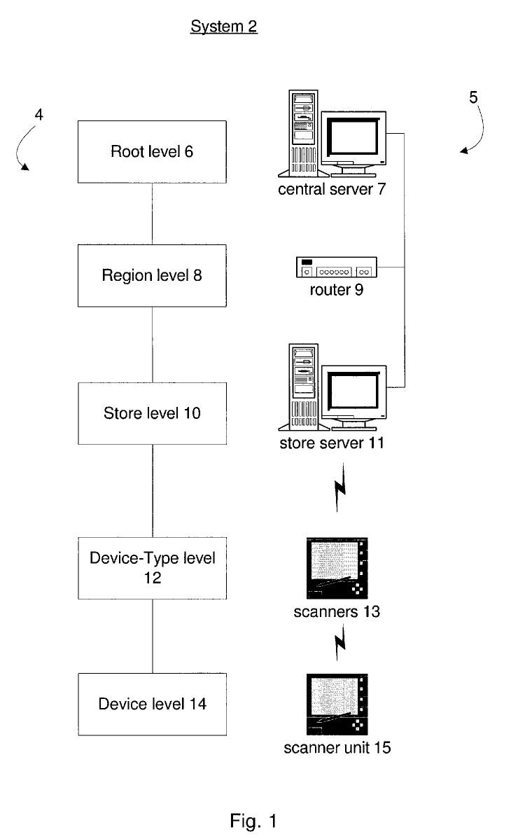

FIG. 1 shows an exemplary embodiment of a system 2 for configuring a computing device according to the present invention. The system 2 may comprise a computing network 5 utilized by an enterprise (e.g., business, school, hospital, etc.). In FIG. 1, the network 5 is represented schematically as a hierarchy 4. Levels in the hierarchy 4 may include various computing devices, networks, subnets, etc. While the exemplary embodiment of the hierarchy 4 shown in FIG. 1 is a global view of the network 5, those skilled in the art will understand that the hierarchy 4 may be scalable to represent portions of the network 5, e.g., regions, individual stores, etc. In that case, data from the portions may be analyzed individually and/or collectively to monitor operation of the computing devices within each level.

A root level 6 of the hierarchy 4 may represent a headquarters of the enterprise at which one or more central servers 7 and/or databases may be deployed. The central server 7 may implement a Mobility Services Platform (MSP) software package for monitoring all (or selected ones) of the computing devices in the network 5. The MSP may harvest data from the computing devices individually or at central collection sites within the levels. Those skilled in the art will understand that data flow through the network 5 may be bi-directional in asynchronous and/or synchronous manners.

A region level 8 may represent geographic regions in which the network 5 is deployed. A coarse location identifier (e.g., a region identifier) may identify each region. For example, the geographic regions may be identified by continents, regional areas (e.g., northeast US) countries, states, cities, towns, etc. Alternatively, the region level 8 may be divided into economic centers, e.g., northeast US=Boston, New York City. Those skilled in the art will understand that portions of the network 5 identified at the region level 8 may be segmented using various criteria. The region level 8 may comprise network infrastructure devices (e.g., routers 9, bridges, repeaters, etc.) and/or networks (e.g., the Internet, PSTNs, VPNs, etc.) which the central server 7 uses to communicate with the computing devices in the network 5.

A store level 10 may represent individual stores and networks implemented therein. Each store may be identified by a fine location identifier (e.g., a store identifier). For example, a store network may comprise a store server 11 and/or database, a networking device (e.g., a switch, a bridge) and client devices utilized in the store. The networking device allows the store network to communicate with the central server 7.

A device-type level 12 may represent a class of client devices utilized in the store. Each class may be identified by a class identifier indicative of groups of client devices such as, for example, scanners 13 (imager- and/or laser-based), RFID readers, mobile phones, laptops, PDAs, tablet computers, digital cameras, portable gaming devices and/or media players, etc. The classes may further identify stationary devices such as servers, databases, PCs, smart devices (e.g., copiers, fax machines, printers, etc.), etc. that are deployed in the store network. In another exemplary embodiment, the classes may be indicative of device models, operating systems, firmware, etc.

A device level 14 may identify individual ones of the client devices, e.g., a scanner unit 15. That is, each of the client devices in the store may be identified by a device identifier such as, for example, a MAC address, an IP address, a proprietary ID, a serial number, etc. In one exemplary embodiment, when the client device is first used in the network 5, the identifiers associated with the client device are compiled into a device profile 400 (shown in FIG. 4) that is transmitted to and stored by the central server 7 (or other parent device of the client device). This allows the central server 7 to track and monitor operation of the client devices deployed in the network 5.

As described above, there may be a plurality of devices at each of the different levels 6-14 that may be used in the enterprise system 2. Furthermore, there may be multiple subnets within each level. For example, a retail chain that has hundreds of stores may therefore, have hundreds of different subnets at the store level 10, resulting in a corresponding greater number of device types and devices at levels 12 and 14, respectively. The issue that arises may be that the system administrator of the enterprise system 2 desires to enforce a consistent configuration policy administration across the entire system 2. The resulting problem has several aspects including, how can a policy defined at the enterprise level (e.g., root level 2) get propagated to devices at each of the levels 8-14, how can such an enterprise policy be overridden at one of the more local levels 8-14 when needed, etc. The exemplary embodiments of the present invention provide for such enterprise wide configuration policy enforcement, including exceptions at various local levels as needed.

The exemplary embodiments of the present invention provide for a configuration file that may be expressed in the form of a text file (e.g., XML, ASCII, etc.). The configuration text file may include placeholders for parameters. When a device needs to be configured, the values for the parameters may be plugged into the configuration file and uploaded to the device. This allows for configuration policy administration to be implemented by managing the configuration parameters and their values. The configuration file may be created manually or the current configuration from a test device could be exported to MSP. The exported configuration file could be used as a “golden configuration” file and place holders may be added to it.

The values of the configuration parameters may be enforced throughout the entire enterprise system 2 based on inheritance from parent levels to child levels. For example, if a parameter value were set at the root level 6, the value may be inherited throughout all the child levels 8-14. Thus, the parameter value would be consistent across all the devices within the enterprise system 2. However, the exemplary embodiments also allow for parameter values to be changed (or set) at any of the various levels as needed. For example, if the regions in region level 8 are separated by time zone, a time zone configuration parameter value may be set at the region level 8. Thus, all devices in each region will inherit the time zone configuration parameter from the region level 8, rather than the enterprise level 6. Those skilled in the art will understand that other parameter values may be set at each of the various levels as needed.

When a device is being configured, it may search for the parameter value in a hierarchical manner. The device may search from a most specific level to a least specific level to determine the value that should be used for the device configuration. For example, when a device searches for a parameter value, it may begin the search at the device level 14 to determine if there is a value that has been assigned for that device. If there is a defined value at level 14, the device would use the value for configuration purposes. If there is not, the device would go up the hierarchy to the device-type level and determine if there is a value defined at level 12. The device may continue the search until it finds a level where the parameter value is defined and then adopt that value. It should be noted that there may be sub-levels or categories within each level. For example, device type level 12 is shown as a child of store level 10. However, there may be a separate device type level (not shown) that is a direct child of the region level 8. Thus, a parameter value may be defined in terms of a region level device type parameter. Those skilled in the art will understand that any number of levels and/or sub-levels may be defined in order to manage the configuration of the devices.

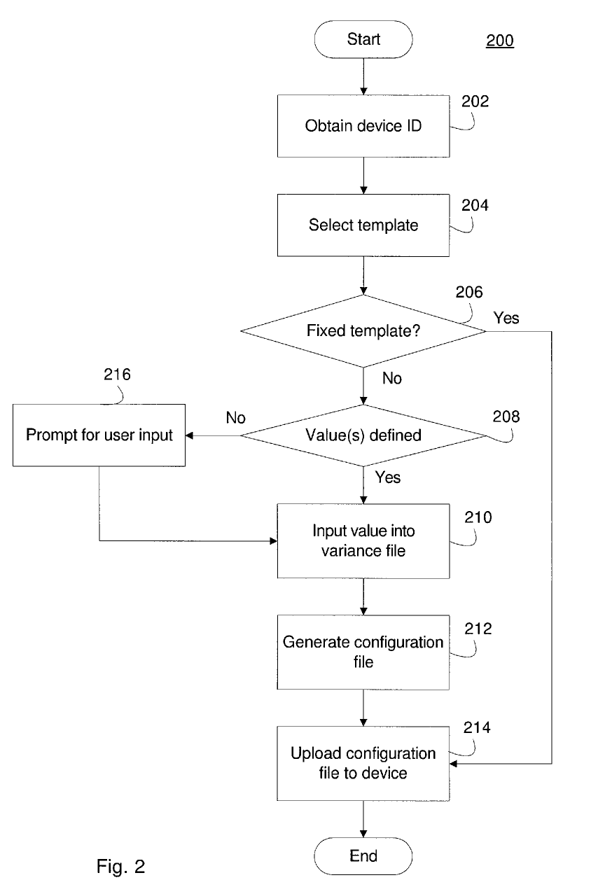

FIG. 2 shows an exemplary embodiment of a method 200 for configuring a computing device according to the present invention. In the exemplary embodiment, an operator using the central server 7 may remotely configure any one or more devices in the network 5 individually and/or collectively. Those skilled in the art will understand that the method 200 may be implemented on a local level by, for example, configuring a client device by using the store server (e.g., the store server 11 configure the scanner unit 15).

Configuration data loaded on the computing devices in the network 5 which may be changed includes, but is not limited to, communication protocols, security protocols, security keys/certificates, user interface settings, operational settings (e.g., sleep/wake), etc. While the client devices may be configured via wireless transmissions (e.g., from wireless access points/ports and/or wireless switches), the client devices may also be configured using wired connections. For example, after a shift, an employee may dock the scanner unit 15 in a charging cradle to be charged. The dock may also be coupled to the store server 15 (e.g., via Ethernet, serial, USB) allowing the scanner unit 15 to communicate data with the store server 11 (and/or the central server 7) between shifts. Those skilled in the art will understand that the method 200 may be used for the initial configuration of the device or for any reconfiguration that is required during the operating life of the device.

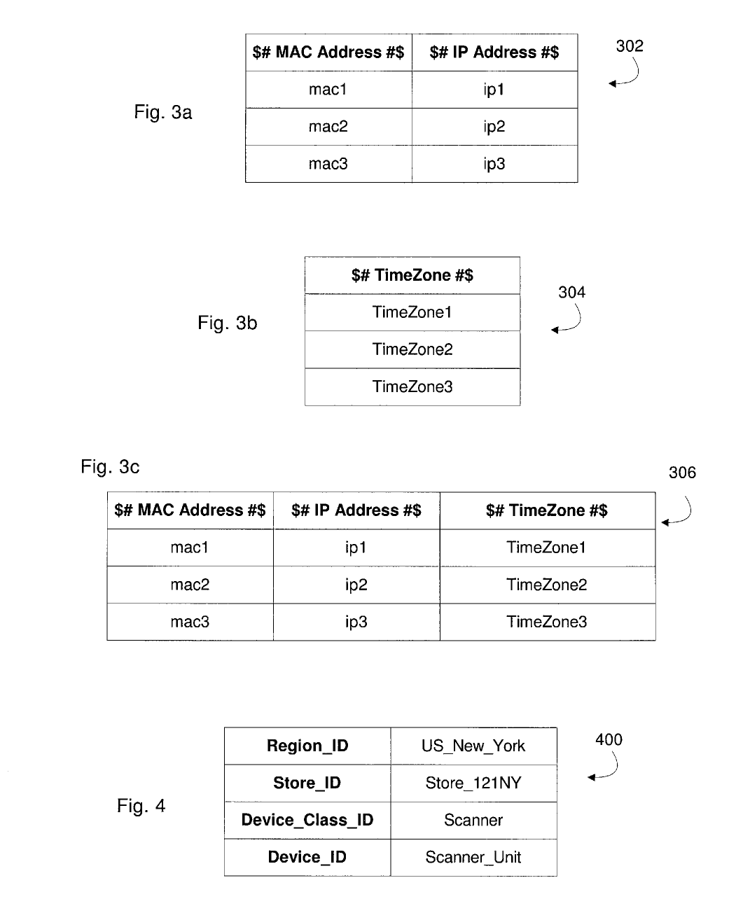

In step 202, the device identifier(s) for the client device(s) that are to be configured are obtained. The operator may select any device(s) in the network 5. Based on the selection, the device identifiers for the selected devices are obtained from the profiles thereof by the central server 7. The device identifiers may then be loaded into a skeleton variance file 302, as shown in FIG. 3a. The skeleton variance file will be discussed in greater detail below and may not be generated at this time, but may also be generated later in the process based on the configuration that is going to be performed. Furthermore, there may be configurations that do not require the skeleton variance file because, as described below, there are no variable parameter values for certain configurations. It should also be noted that the generation of the skeleton variance file with device information included may be performed by the device being used to configure the new device (e.g., the store server 11) or any other device. The generation of the skeleton variance with the device identifications pre-filled aids the operator in that manual entry of these identifications is eliminated. In the exemplary embodiment, three client devices are selected and the corresponding device identifiers, e.g., MAC and IP addresses, are mac1/ip1, mac2/ip2 and mac3/ip3.

In step 204, a template is selected for configuring the client devices. In the exemplary embodiment, four choices exist for the template: (i) full-fixed, (ii) full-variable, (iii) partial-fixed and (iv) partial-variable. The full-fixed template contains all of the configuration data for a corresponding device and does not include any variables. Thus, the full-fixed template already includes parameter values for all of the variables in the template. The full-variable template contains all of the configuration data and has one or more variables, which require values for configuring parameters associated with those variables. The partial-fixed template contains a subset of the configuration data (e.g., only security keys) for the corresponding device and does not include any variables. The partial-variable template contains a subset of the configuration data and has one or more variables. In the exemplary embodiment, a partial-variable template 304 having a time zone variable is selected, as shown in FIG. 3b. The template 304 may be utilized to configure the time zone utilized by each of the client devices. The partial templates may be stored with place-holders (e.g., TimeZone1, etc.) which are replaced by values for each of the client devices.

In step 206, it is determined whether the selected template is the full-fixed template or the partial-fixed template. In either of these cases, the template does not have any variables and may be uploaded to the client devices for configuration, as shown in step 214. Upon receipt of the fixed template, the client devices may utilize the values contained therein for configuration.

In the exemplary embodiment, the partial-variable template 304 is selected, thus the method 200 continues to step 208 where it is determined whether values are defined for the variables in the partial-variable template 304 (or full-variable template in other embodiments). In the exemplary embodiment, the values are obtained in a reverse hierarchical lookup process as described above. That is, the central server 7 may first determine whether a value has been defined for the variable for the client device based on the client identifier. For example, the central server 7 may analyze the profile containing the device identifier mac1/ip1 to determine whether a value has been defined for the time zone variable for that specific device. If the value is identified, the method proceeds to step 210.

If the value is not identified in the profile for the client device, the central server 7 determines the value by analyzing the configuration data of other client devices in, for example, the same device-class as the client device. Preferably, the other client device also are utilized in the same store and in the same region. Thus, the central server 7 attempts to find the value of the variable beginning with the other client devices that have a greatest number of identifiers in common with the client device, and on up to the root level 6. In the exemplary embodiment, the value for the time zone variable may be defined at the store level 10. The value may apply to all computing devices utilized in the store network.

In another exemplary embodiment, after reaching the root level 6, no value for the time zone variable is detected, the central server 7 may prompt the operator to enter the value, as shown in step 216.

In step 210, the value for the time zone variable has been obtained and is now input into a variance file 306, as shown in FIG. 3c. The variance file 306 contains the values for all of the variables in the template 304. That is, the central server 7 may have determined a value for each of the client devices identified in the skeleton variance file 302. In the exemplary embodiment, the search by the central server 7 yielded a different value for each of the client devices.

In step 212, the central server generates a configuration data file using the template and the variance file 306. The configuration data file may be a text file (e.g., XML, etc.). In step 214, the configuration data file is uploaded to the client devices. As understood by those of skill in the art, the client device may utilize the value associated with its device identifier and ignore the values associated with the other device identifiers. In other exemplary embodiments, the configuration data file may be segmented on a per-device basis and transmitted individually to each device.

While the exemplary embodiment has been described with reference to a value being input into the variance file, those skilled in the art will understand that some variables may require a command(s), a function, a pointer, a data address, user-created, etc. For example, the value may be a set of commands for creating a WLAN. A null value may also be inserted into the variance file. The value may also be a predefined variable (e.g., a timestamp) and/or an auto-incrementing to a previous value.

As understood by those skilled in the art, the exemplary embodiments of the present invention allow the configurations of a plurality of devices to be monitored at a central site. As stated above, configuration data may be propagated from the central site (or at any computing device) through a computing network to all or selected ones of the computing devices. Also, by associating values with different levels in the network, the configuration data files for each of the devices may not require a significant amount of storage space.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
obtaining a device identifier of a computing device;
determining a first configuration value for the device as a function of the device identifier;
generating a configuration data file as a function of the first configuration value; and
transmitting the configuration data file to the device, the first configuration value in the configuration data file replacing a second configuration value utilized by the device.

2. The method according to claim 1, wherein the device identifier includes at least one of a medium access control (MAC) address, an Internet Protocol (IP) address and a serial number.

3. The method according to claim 1, wherein the device identifier is included in a device profile, the device profile further including at least one of a device-class identifier, a fine location identifier and a coarse location identifier.

4. The method according to claim 3, wherein the determining includes:
when the device profile does not include the first configuration value, analyzing a further device profile of a further computing device to determine the first configuration value, the further device profile including at least one of the device-class identifier, the fine location identifier and the coarse location identifier.

5. The method according to claim 1, wherein the device is one of an imager-based barcode scanner, a laser-based barcode scanner, an RFID reader, an RFID tag, a mobile phone, a PDA, a laptop, a digital camera, a PC, a copier, a switch, a bridge, a router, a server and a database.

6. The method according to claim 1, wherein the first configuration value is indicative of at least one of a communication protocol, a security protocol, a security keys, a certificate, a user interface setting and an operational setting.

7. The method according to claim 1, further comprising:
selecting a template for adjusting the second configuration value.

8. The method according to claim 7, wherein the template is one of a full-fixed template, a partial-fixed template, a full-variable template and a partial-variable template.

9. The method according to claim 8, wherein, when the template is one of the full-fixed template and the partial-fixed template, the template includes the first configuration value.

10. The method according to claim 8, wherein, when the template is one of the full-variable template and the partial-variable template, executing the following steps:
inputting the first configuration value into a variance file; and
associating the first configuration value with a variable in the template to generate the configuration data file.

11. A method, comprising:
obtaining a device identifier from a device profile of a computing device, the device identifier being included in profile data stored in the device profile;
analyzing the profile data to determine a first configuration value for the device;
when the profile data does not include the first configuration value, analyzing a further device profile of a further computing device to determine the first configuration value, the further device profile including further profile data, at least a portion of which is substantially similar to the profile data;
generating a configuration data file as a function of the first configuration value; and
transmitting the configuration data file to the device, the first configuration value in the configuration data file replacing a second configuration value utilized by the device.

12. The method according to claim 11, wherein the device profile further includes at least one of a device-class identifier, a fine location identifier and a coarse location identifier.

13. The method according to claim 12, wherein the further device profile includes at least one of the device-class identifier, the fine location identifier and the coarse location identifier.

14. The method according to claim 11, wherein the first configuration value is indicative of at least one of a communication protocol, a security protocol, a security keys, a certificate, a user interface setting and an operational setting.

15. The method according to claim 11, further comprising:
selecting a template for adjusting the second configuration value.

16. The method according to claim 15, wherein the template is one of a full-fixed template, a partial-fixed template, a full-variable template and a partial-variable template.

17. The method according to claim 16, wherein, when the template is one of the full-fixed template and the partial-fixed template, the template includes the first configuration value.

18. The method according to claim 16, wherein, when the template is one of the full-variable template and the partial-variable template, executing the following steps:
inputting the first configuration value into a variance file; and
associating the first configuration value with a variable in the template to generate the configuration data file.

19. A computing arrangement, comprising:
a memory storing a plurality of device profiles corresponding to a plurality of computing devices; and
a processor analyzing a selected device profile to determine a configuration value for a corresponding computing device, the processor generating a configuration data file as a function of the configuration value.

20. The arrangement according to claim 19, wherein the processor transmits the configuration data file to the corresponding computing device, the configuration value in the configuration data file replacing a further configuration value utilized by the corresponding computing device.

21. The arrangement according to claim 20, wherein the selected device profile further includes at least one of a device-class identifier, a fine location identifier and a coarse location identifier.

22. The arrangement according to claim 21, wherein, when the selected device profile does not include the first configuration value, the processor analyzes a further device profile of a further computing device to determine the first configuration value, the further device profile including at least one of the device-class identifier, the fine location identifier and the coarse location identifier.

23. A device, comprising:
a memory means for storing a plurality of device profiles corresponding to a plurality of computing devices; and
a processing means for analyzing a selected device profile to determined a first configuration value for a corresponding computing device, the processing means generating a configuration data file as a function of the first configuration value.
